(19) United States
(12) Patent Application Publication
(10) Pub. No.: US 2016/0049812 A1
(43) Pub. Date: Feb. 18, 2016

(54) BATTERY EXPANSION SYSTEM HAVING A SINGLE ROUTE FOR CHARGING AND DISCHARGING AND BATTERY CHARGING AND DISCHARGING CONTROL METHOD THEREOF

(71) Applicant: IEI Integration Corp., New Taipei City (TW)

(72) Inventor: Wei-Hung Li, New Taipei City (TW)

(21) Appl. No.: 14/514,394

(22) Filed: Oct. 15, 2014

(30) Foreign Application Priority Data
Aug. 12, 2014 (CN) 201410394883.9

(51) Int. Cl. H02J 7/00

(52) U.S. Cl. CPC H02J 7/0019; H02J 7/007

(57) ABSTRACT

A battery expansion system and a battery charging and discharging control method configure the cells as an expansion form to connect to a system host such that the charger IC of the system host treats the battery expansion system as a single battery cell for DC charging and discharging control. The battery expansion system utilizes a controller in control of the charge/discharge route for each battery cell. In such way, each battery cell is capable of providing power for the system host or charging another cell until the battery cells are balanced with one another. With the control of a current control device and a charging switch in the charging/discharging route, the controller may effectively limit the charging current toward each cell under the maximum design charging current once a current impulse or in-rush current occurs.

### BACKGROUND OF THE INVENTION

1. Field of the Invention

The present invention relates to a battery expansion system and a battery charging and discharging control method, and more particularly, to a battery expansion system having a single route for charging and discharging and battery charging and discharging control method thereof.

2. Description of the Prior Art

Power supply design of a mobile system plays an important role in keeping the mobile system in operation. It's been an important issue in this field to design power supply of the mobile system so that the mobile system plays full functionality for as long as possible without being forced to accommodating the power concern. Although a mobile system can be powered by using plugged-in power source, which apparently impacts the mobility of the mobile system, utilizing energy storage elements has become a common practice in providing power for the mobile system, especially when AC main power is so not suitable as the power input and mobility is one of the core demands from the mobile system.

For example, a mobile medical workstation usually used in a medical environment includes a system host and at least one built-in battery module for providing power for the system host. Due to characteristic of the environment the mobile medical workstation usually undergoes, the mobile medical workstation is required to not only be operated for a long period of time but also be shifted between locations quite often. Such special use condition leads to a serious requirement of power supply of the battery module for this type of mobile system. Additionally, for other mobile systems used in non-medical environments, same requirement exists. Although a battery with large capacity can be disposed for long-time use, it still has to be replaced or connected to AC mains power for charging before the power runs out. These actions certainly interrupt the operation of the mobile system.

Presently, another solution is to include a further battery expansion slot for installing a second battery module in addition to an original battery module. Extra power is provided accordingly and the second battery module is replaceable. However, the battery module installed on the battery expansion slot has a limited capacity. If the mobile system is to be provided with a second battery module with larger capacity, either a battery module with another specification has to be considered or the design of the mobile system has to be modified so as to include more battery expansion slots. These practices are less convenient.

### SUMMARY OF THE INVENTION

The present invention provides a battery expansion system having a single route for charging and discharging so as to provide battery expansion solutions with more flexibility for a system host.

According to an embodiment of the present invention, a battery expansion system having a single route for charging and discharging is provided. The battery expansion system is detachably installed on a system host to provide power for the system host or for the system host to charge the battery expansion system. The battery expansion system includes a first battery cell, a second battery cell, a first charge and discharge circuit, a second charge and discharge circuit, and a controller. The first charge and discharge circuit is coupled between the first battery cell and the system host. The second charge and discharge circuit is coupled between the second battery cell and the system host. The controller is coupled to the first charge and discharge circuit, the second charge and discharge circuit, the first battery cell, and the second battery cell. The first charge and discharge circuit includes a first charge switch, a first discharge switch, and a first current control device. The first discharge switch is coupled between the first charge switch and the first current control device. The first current control device is coupled to the first battery cell. The second charge and discharge circuit includes a second charge switch, a second discharge switch, and a second current control device. The first charge switch, the second charge switch, and the system host are coupled to one another. The second discharge switch is coupled between the second charge switch and the second current control device. The second current control device is coupled to the second battery cell. The controller is used for activating the first discharge switch or the second discharge switch such that correspondingly the first battery cell or the second battery cell provides power for the system host, and activating the first charge switch or the second charge switch such that the system host charges correspondingly the first batter cell or the second batter cell.

According to another embodiment of the present invention, a battery charging and discharging control method is provided. A battery expansion system, having a single route for charging and discharging and detachably installed on a system host, provides power for the system host or for the system host to charge the battery expansion system. The battery expansion system includes a first battery cell and a second battery cell. The battery charging and discharging control method includes the following steps: forming a first charge and discharge circuit between the first battery cell and the system host, the first charge and discharge circuit including a first charge switch, a first discharge switch, and a first current regulation device, the first discharge switch coupled between the first charge switch and the first current regulation device, and the first current regulation device coupled to the first battery unit; forming a second charge and discharge circuit between the second battery cell and the system host, the second charge and discharge circuit including a second charge switch, a second discharge switch, and a second current regulation device, the first charge switch, the second charge switch and the system host coupled to one another, the second discharge switch coupled between the second charge switch and the second current regulation device, the second current regulation device coupled to the second battery unit; activating the first discharge switch or the second discharge switch such that correspondingly the first battery cell or the second battery cell provides power for the system host; and activating the first charge switch or the second charge switch such that the system host charges correspondingly the first battery cell or the second battery cell.

According to the battery expansion system and the battery charging and discharging control method of the present invention, the controller is further used for activating the first charge switch or the second charge switch such that correspondingly the second battery cell charges the first battery cell or the first battery cell charges the second battery cell.

According to the battery expansion system and the battery charging and discharging control method of the present invention, the controller is used for activating the second charge switch such that the first battery cell charges the second battery cell when the controller detects electric potential of the first battery cell is greater than electric potential of the second batter cell by a setting value.

According to the battery expansion system and the battery charging and discharging control method of the present invention, the first current control device includes a first current-limiting circuit and a first current regulation device in parallel connection, and the second current control includes a second current-limiting circuit and a second current regulation device in a parallel connection.

According to the battery expansion system and the battery charging and discharging control method of the present invention, the controller is used for activating the first current regulation device or the second current regulation device such that the first battery cell or the second battery cell provides power for the system host when the controller activates correspondingly the first discharge switch or the second discharge switch.

According to the battery expansion system and the battery charging and discharging control method of the present invention, the controller is used for activating the first current regulation device or the second current regulation device such that the system host charges the first battery cell or the second battery cell when the controller activates correspondingly the first charge switch or the second charge switch.

According to the battery expansion system and the battery charging and discharging control method of the present invention, the controller is used for detecting a charge current of the first battery cell when the controller activates the first charge switch for charging the first battery cell, and the controller is used for deactivating the first current regulation device and activating the first current-limiting circuit to limit the charge current to be less than a critical value when the charge current is greater than the critical value.

According to the battery expansion system and the battery charging and discharging control method of the present invention, the controller is further used for controlling activation and deactivation of the first charge switch by pulse width modulation (PWM) so as to limit the charge current of the first battery cell.

According to the battery expansion system and the battery charging and discharging control method of the present invention, the controller is further used for detecting battery statuses of the first battery cell and the second battery cell and deactivating the first discharge switch when an abnormal battery status of the first battery cell occurs.

According to the battery expansion system and the battery charging and discharging control method of the present invention, the abnormal battery status of the first battery cell includes one of the following: the first battery cell absent from coupling to the first discharge circuit; the controller unable to acquire the battery status of the first battery cell; and the controller acquiring abnormal information from the first battery cell.

According to the battery expansion system and the battery charging and discharging control method of the present invention, the controller is used for activating the corresponding first discharge switch or the second discharge switch when the battery status of the first battery cell or the second battery cell is normal.

According to the battery expansion system and the battery charging and discharging control method of the present invention, an expansion seat is further included. The first battery cell and the second battery cell are detachably installed on the expansion seat. The first charge and discharge circuit, the second charge and discharge circuit, and the controller are disposed in the expansion seat. The first charge and discharge circuit and the second charge and discharge circuit separately provide electrical contacts for electrical connections with the first battery cell and the second battery cell respectively when the first battery cell and the second battery cell are installed on the expansion seat.

The battery expansion system and the battery charging and discharging control method configure the cells as an expansion form to connect to a system host such that the charger IC of the system host treats the battery expansion system as a single battery cell for DC charging and discharging control. The battery expansion system utilizes the controller in control of the charge/discharge route for each battery cell. In such way, each battery cell is capable of providing power for the system host or charging another battery cell until the battery cells are balanced with one another. With the control of a current control device and a charging switch in the charging/discharging route, the controller may effectively limit the charging current toward each cell under the maximum design charging current. Each battery cell of the battery system is capable of detached and replaced at any time so that the battery expansion system has more flexibility in different applications.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a battery expansion system having a single route for charging and discharging, and a system host of the present invention.

FIG. 2 is a schematic diagram of the battery expansion system and the system host according to a first embodiment of the present invention.

FIG. 3 is a functional block diagram of the battery expansion system and the system host according to a second embodiment of the present invention.

FIG. 4 is a flow chart when battery cells of the battery expansion system discharge.

FIG. 5 and FIG. 6 are flow charts when battery cells of the battery expansion system are charged.

### DETAILED DESCRIPTION

Certain terms are used throughout the description and following claims to refer to particular components. As one skilled in the art will understand, electronic equipment manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ” In addition, the term “couple” is intended to mean either an indirect or direct electrical/mechanical connection. Thus, if a first device is coupled to a second device, that connection may be through a direct electrical/mechanical connection, or through an indirect electrical/mechanical connection via other devices and connections.

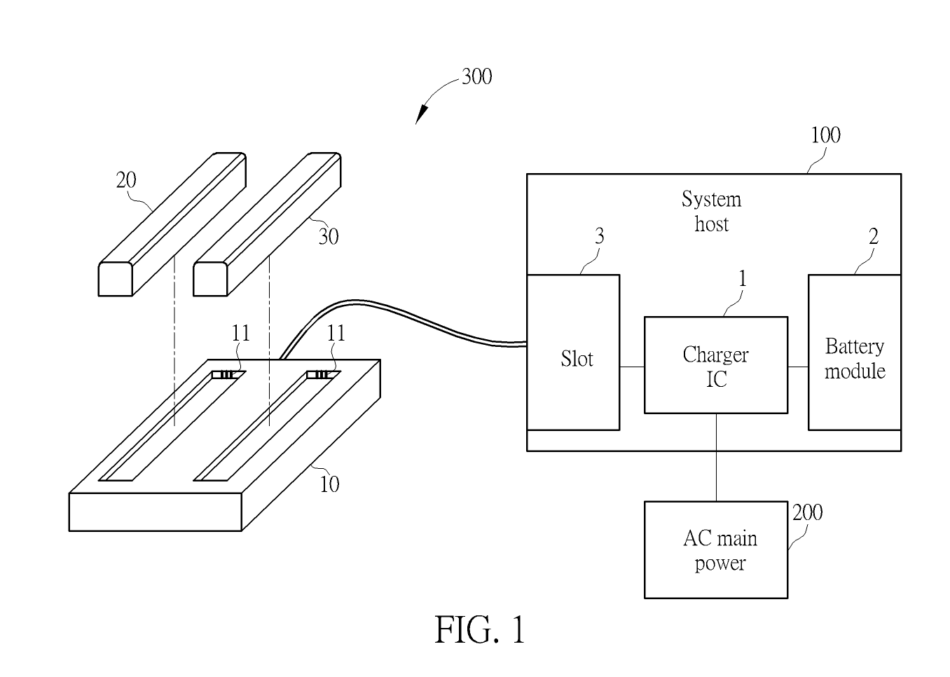

Please refer to FIG. 1. FIG. 1 is a schematic diagram of a battery expansion system having a single route for charging and discharging, and a system host of the present invention. The system host 100 is a mobile system, such as a mobile medical workstation, and includes a charger IC 1, a battery module 2, and a slot 3 where another battery module may be detachably installed thereon, or to be coupled with a battery expansion system 300 of the present invention, such that a first battery cell 20 and a second battery cell 30, which are included in the battery expansion system 300, can provide power for the system host 100. The charger IC 1 may be connected to an AC main power 200 to charge the battery module 2 and another battery module on the slot 3, not shown in the figure. The system host 100 is capable of charging the first battery cell 20 and the second battery cell 30 when the slot 3 is coupled with the system host 300. In the present invention, the charger IC 1 of the system host 100 receives the AC power and charges the first battery cell 20 and the second battery cell 30 with DC power. It should be noted that the first battery cell 20 or the second battery cell 30 can also be directly installed on the slot 3 as another battery module for the system host 100. In other words, the battery module that can be installed on the slot 3, the battery module 2 that can be made detachable, the first battery cell 20, and the second battery cell 30 can be battery modules having same shape with input/output voltage and current compliant to the specification of the system host 100. In such manner, the battery module 2, the first battery cell 20, and the second battery cell 30 may be shareable and interchangeable components with one another, which saves a cost of providing battery modules with different specifications.

According to the present invention, the system host 300 includes an expansion seat 10 detachably connected to the slot 3. The first battery cell 20 and the second battery cell 30 are detachably installed on the expansion seat 10. When one of the battery cells runs out, the first battery cell 20 for example, it can be detached from the expansion seat 10 at any time and replaced by another battery cell with enough power. Meanwhile, operation of the system host 100 is well-maintained. It should be noted that the battery expansion system 300 does not directly accept the power input from the AC main power 200 and the battery expansion system 300 complete procedures of DC power charging and discharging between with the system host 100 through a same path.

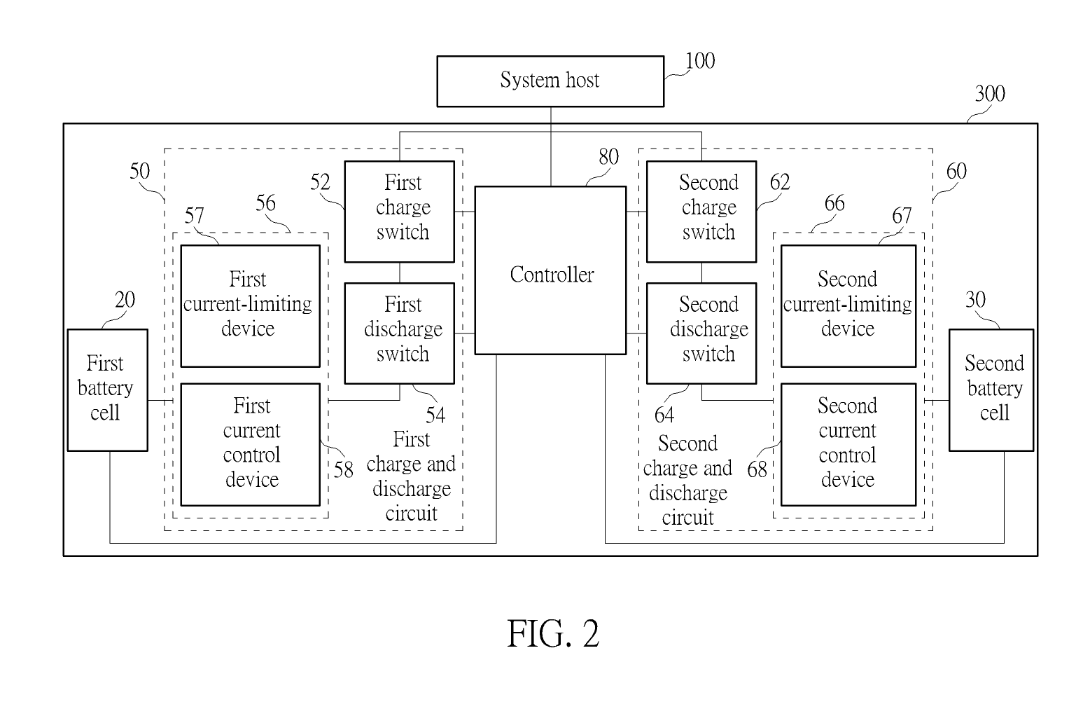

Please refer to FIG. 2. FIG. 2 is a schematic diagram of the battery expansion system and the system host according to a first embodiment of the present invention. In the first embodiment, the battery expansion system 300 includes a first battery cell 20, a second battery cell 30, a first charge and discharge circuit 50, a second charge and discharge circuit 60, and a controller 80. The first charge and discharge circuit 50 is coupled between the first battery cell 20 and the system host 100, and the second charge and discharge circuit 60 is coupled between the second battery cell 30 and the system host 100 when the expansion seat 10 of the battery expansion system 300 is connected to the slot 3. The controller 80 is coupled to the first charge and discharge circuit 50, the second charge and discharge circuit 60, the first battery cell 20, and the second battery cell 30. The first charge and discharge circuit 50 includes a first charge switch 52, a first discharge switch 54, and a first current control device 56. The first discharge switch 54 is coupled between the first charge switch 52 and the first current control device 56. The first current control device 56 is coupled to the first battery cell 20. Similarly, the second charge and discharge circuit 60 includes a second charge switch 62, a second discharge switch 64, and a second current control device 66. The second discharge switch 64 is coupled between the second charge switch 62 and the second current control device 66. The second current control device 66 is coupled to the second battery cell 30. Please refer to FIG. 1 together with FIG. 2. The first charge and discharge circuit 50, the second charge and discharge circuit 60, and the controller 80 are disposed in the expansion seat 10, not shown in FIG. 1. The first charge and discharge circuit 50 and the second charge and discharge circuit 60 separately provide electrical contacts 11 for establishing electrical connections with the first battery cell 20 and the second battery cell 30 respectively when the first battery cell 20 and the second battery cell 30 are installed on the expansion seat 10 such that the coupling relations are formed as shown in FIG. 2.

As shown in FIG. 2, the first charge switch 52, the second charge switch 62, and the system host 100 are coupled to one another. In fact, when the battery expansion system 300 is connected to the system host 100, the charger IC 1 of the system host 100 considers the battery expansion system 300 as a single battery module and controls charging and discharging of the battery module 2 and the battery expansion system 300 in the same way. Individual charging and discharging operation of the first battery cell 20 and the second battery cell 30 in the battery expansion system 300, and balance between each other are controlled by the controller 80 in the battery expansion system 300. Details of a charging and discharging control method are described later.

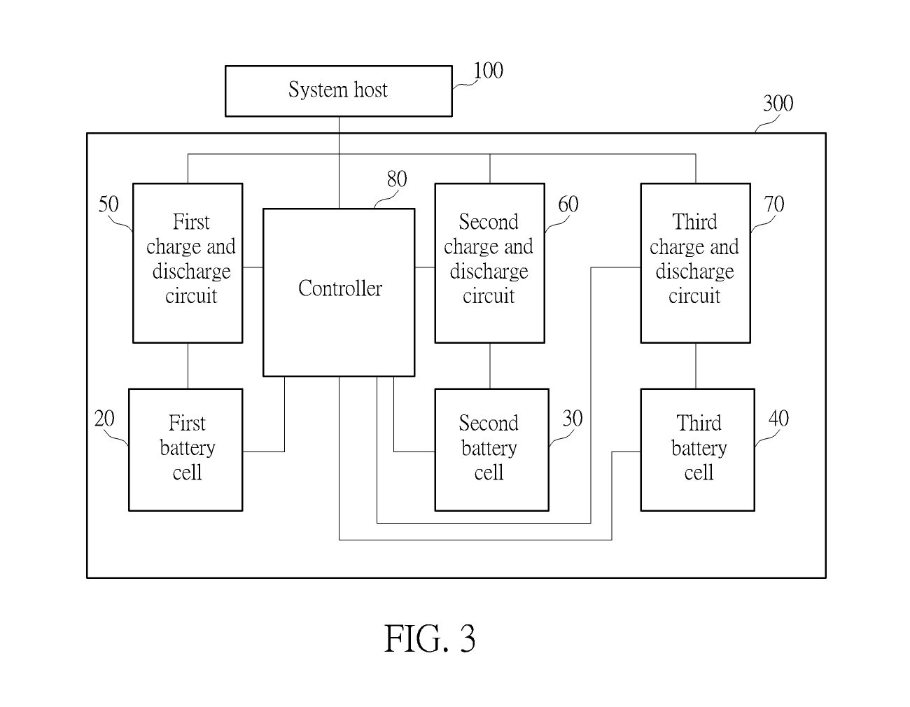

Please refer to FIG. 3. FIG. 3 is a functional block diagram of the battery expansion system and the system host according to a second embodiment of the present invention. Besides the embodiment as shown in FIG. 1 and FIG. 2 that the battery expansion system 300 configures to have two battery cells, the first battery 20 and the second battery cell 30, the present invention is not limited to the first embodiment and provides a second embodiment that the battery expansion system 300 may further configure to have a third battery cell 40 and a third charge and discharge circuit 70 as shown in FIG. 3. Components included in the third charge and discharge circuit 70, the coupling relations among third battery cell 40 and the third charge and discharge circuit 70, the controller 80, and the system host 100 are the same as mentioned above, and therefore the descriptions of the third set are omitted herein for simplicity. Design of the expansion seat 10 of the battery expansion system 300 is correspondingly modified from the first embodiment, as shown in FIG. 1, to the second embodiment capable of having three battery cells, as shown in FIG. 3. In other embodiments, a further design of the battery expansion system having a fourth battery cell, a fifth battery cell and so on, can proceed.

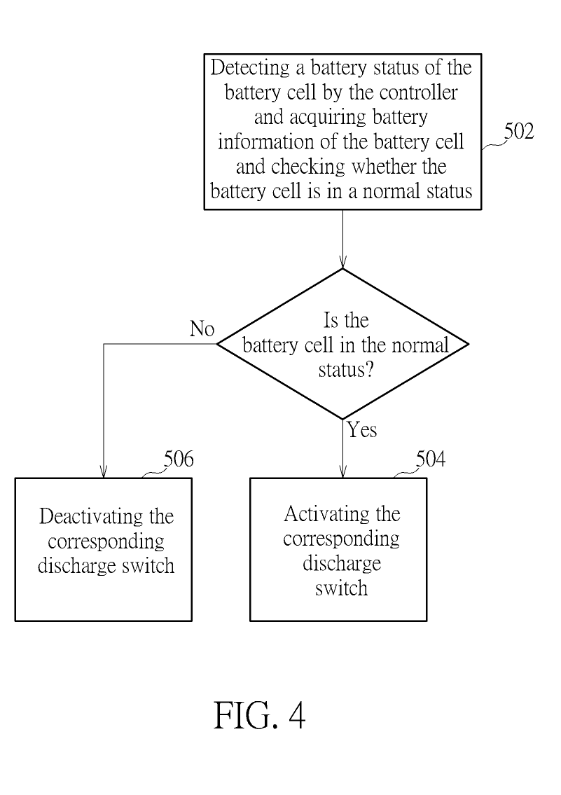

Please refer to FIG. 4. FIG. 4 is a flow chart when battery cells of the battery expansion system discharges. After the battery cells of the battery expansion system 300, the first battery cell 20 and/or the second battery cell 30, are installed on the expansion seat 10, the battery cells can be controlled to provide power for the system host 100. A control method for each battery cell includes the following steps:
step 502: detecting a battery status of the battery cell by the controller and acquiring battery information of the battery cell and checking whether the battery cell is in a normal status;
step 504: activating the corresponding discharge switch when the battery cell is in a normal status; and
step 506: deactivating the corresponding discharge switch when the battery cell is in an abnormal status.

During the discharging stage of the battery cells, if one of the charge and discharge circuits is not in connection with the battery cell, for example, if the first battery cell 20 is not installed on the expansion seat 10, i.e., the first charge and discharge circuit 50 is not in connection with the first battery cell 20, the controller 80 will deactivate the first discharge switch 54, which is one of the abnormal battery statues, absence of the battery cell, according to step 502. Additionally, if the first battery cell 20 so malfunctions that the controller 80 cannot acquire the battery information from the first battery cell 20 or acquires abnormal battery information, abnormal battery status is also determined in step 502 and step 506 will proceed to deactivate the first discharge switch 54. Meanwhile, the controller 80 will also deactivate the first charge switch 52 and thus considers the first battery cell 20 as an abnormal battery cell so that the first battery cell 20 will not be charged or discharged. If the second battery cell 30 has no abnormal information as the first battery cell 20 as mentioned above, the controller 80 determines the second battery cell 30 as a normal battery cell. Thus, in step 504, the controller 80 activates the second discharge switch 64. Under this condition, only the second battery cell 30 is in normal operation in the battery expansion system 300 and the second discharge switch 64 keeps being activated in the process of operation. Furthermore, the second current control device 68 is also activated so that the current of the second battery cell 30 flows through the second current control device 68 and the second discharge switch 64. If both the two battery cells are in the normal status, the controller 80 will activate both the first discharge switch 54 and the second discharge switch 64 so that both the two battery cells can provide power for system host 100. At the same time, the first current control device 58 and the second current control device 68 will also be activated. For the system host 100, the battery expansion system 300 is regarded as a battery module having twice as much as capacity of a single battery cell. Besides, when one battery cell is either in a normal status, an abnormal status, or not installed on the expansion seat 10, the expansion seat 10 provides indication lamps, which is not shown in FIG. 1, with corresponding colors at the location corresponding to the battery cell.

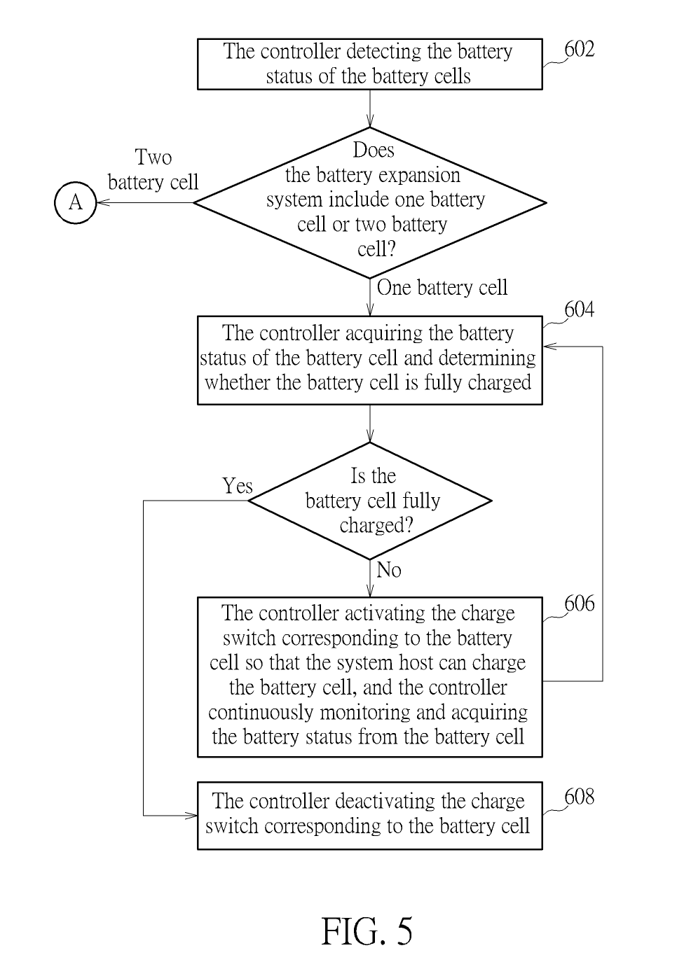

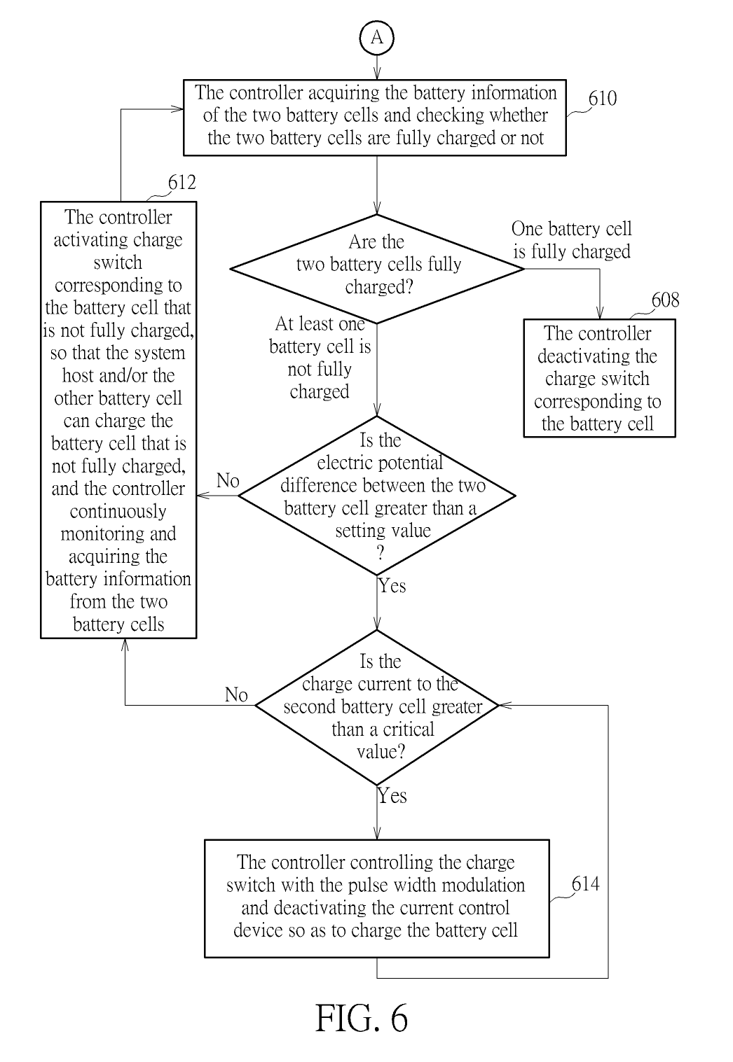

Please refer to FIG. 5 and FIG. 6. FIG. 5 and FIG. 6 are flow charts when battery cells of the battery expansion system charges. After the battery cells of the battery expansion system 300, the first battery cell 20 and/or the second battery cell 30, are installed on the battery expansion system 10 and go over the checking procedure in the above mentioned steps 502 to 506, the first battery cell 20 and/or the second battery cell 30 are ready to provide power for the system host 100, whereas the system host 100 is also ready to charge any one of the battery cells. The operation method includes the following steps:
step 602: the controller detecting the battery status of the battery cells;
step 604: if only one battery cell is installed, the controller acquiring the battery status of the battery cell and determining whether the battery cell is fully charged;
step 606: if the battery cell is not fully charged, the controller activating the charge switch corresponding to the battery cell so that the system host can charge the battery cell, and the controller continuously monitoring and acquiring the battery status from the battery cell; and
step 608: the controller deactivating the charge switch corresponding to the battery cell when the battery cell is fully charged.

In a stage that the battery cell is ready to be charged, when only one battery cell is ready to be charged or discharged, for example, the first battery cell 20 is detected in step 604 to be normally charged and discharged, the controller 80 determines whether the first batter cell 20 is fully charged or not and activates the first charge switch 52 according to step 606 if the first battery cell 20 is not fully charged, so that the system host 100 may charge the first battery cell 20 when the first battery cell 20 is ready to be charged by the system host 100. At the same time, the expansion seat 10 displays the indication lamps in a corresponding color at the location corresponding to the first battery cell 20. After the first battery cell 20 is fully charged, the controller 80 deactivates the first charge switch 54 immediately and sets the indication lamps in another corresponding color according to step 608. Although the first battery cell 20 is described herein, same determination and charging/discharging control also apply on the second battery cell 30, and description of which is omitted herein for brevity.

When both the first battery cell 20 and the second battery cell 30 are detected and can be charged and discharged normally according to step 602, the steps as shown in FIG. 6 are executed:
step 610: the controller acquiring the battery information of the two battery cells and checking whether the two battery cells are fully charged or not;
step 612: the controller activating charge switch corresponding to the battery cell that is not fully charged, so that the system host and/or the other battery cell can charge the battery cell that is not fully charged, and the controller continuously monitoring and acquiring the battery information from the two battery cells; and step 614: the controller controlling the charge switch with the pulse width modulation and deactivating the current control device so as to charge the battery cell.

When the two battery cells of the battery expansion system 300, or more battery cells, are ready to be charged or discharged, the charging behavior of the battery cells includes the following situations. According to step 610, the controller 80 continuously acquires the battery information including power status from the first battery cell 20 and the second battery cell 30 and learns whether the first battery cell 20 and the second battery cell 30 are fully charged or not. When one, or both, of the first battery cell 20 and the second battery cell 30 is fully charged, the controller 80 deactivates the charge switch corresponding to the battery cell that is fully charged as in step 608. When one or both of the battery cells are not fully charged, the controller 80 proceeds to the following determination.

For example, if the first battery cell 20 is fully charged and the second battery cell 30 is not fully charged, the controller 80 determines whether an electric potential difference between the first battery cell 20 and the second battery cell 30 is greater than a setting value. If the electrical potential difference is less than the setting value, like 5%, it means the electricity of the second battery cell 30 is not far from the electricity of the first battery cell 20, knowing that the first battery cell 20 is currently fully charged. Thus, step 612 is executed directly and the controller 80 activates the second charge switch 62 of the second battery cell 30. If the battery expansion system 300 is also connected to the system host 100 at this moment, the charger IC 1 of the system host 100, as shown in FIG. 1, will charge the second battery cell 30. No matter whether the battery expansion system 300 is connected to the system host 100 or not, the first battery cell 20 will likely charge the second battery cell 30 until the two battery cells are balanced since the electric potential of the fully charged first battery cell 20 is greater than the electric potential of the second battery cell 30 and the first discharge switch 54 is activated. Please refer to FIG. 2. A charge route passes through the second charge switch 62, the second discharge switch 64, which is already activated according to step 504 and maintains a smooth route for discharging behavior of the second battery cell 30, and the second current control device 68. The second current control device 68 is activated by the controller 80 so as to maintain a smooth discharge route. According to step 612, the controller 80 continuously monitors and acquires the battery information from the second battery cell 30. The second charge switch 62 will be deactivated and charging of the second battery cell 30 will be stopped according to step 608 after the second battery cell 30 is fully charged according to the step 610.

If the first battery cell 20 is fully charged and the second battery cell 30 is not fully charged, and if the electric potential difference between the second battery cell 30 and the first battery cell 20 is greater than the setting value, it means the electricity of the second battery cell 30 is far more than the electricity of the first battery cell 20. If the battery expansion system 300 is not connected to the system host 100, the controller 80 continues executing step 612 at this moment so that the first battery cell 20 charges and balances with the second battery cell 30. If the battery expansion system 300 is connected to the system host 100, it may be the case that both the system host 100 and the first battery cell 20 will charge the second battery cell 30 at the same time. Therefore, the controller 80 further determines whether the charge current to the second battery cell 30 is greater than a critical value. The critical value may be a maximum design charge current of the battery cell. If the charge current to the second battery cell 30 is not greater than the critical value, the second battery cell 30 may be properly charged. Therefore, step 612 may be executed that the system host 100 and/or the first battery cell 20 charges the second battery cell 30.

If the first battery cell 20 is fully charged and the second battery cell 30 is not fully charged, and the electric potential difference between the second battery cell 30 and the first battery cell 20 is greater than the setting value, the system host 100 and the first battery cell 20 may both charge the second battery cell 30 at the same time if the battery expansion system 300 is connected to the system host 100. Except for the previous condition, if the charge current to the second battery cell 30 is now greater than the critical value, the controller 80 will activate a charge protection for the second battery cell 30. As mentioned in the step 614, the controller 80 controls the activation and deactivation of the second charge switch 62 with the pulse width modulation so as to conduct a first level current limiting for the charge route of the second battery cell 30. Meanwhile, the controller 80 further deactivates the second current control device 68 such that the charge route of the second battery cell 30 is rerouted and passes through the second current-limiting circuit 67 instead, which is an electrical component with a certain resistance, and a further step of current-limiting may be performed by using a lower current to charge the second battery cell 30. In this process, the controller 80 continuously monitors and acquires the battery information including the charge current to the second battery cell 30, and the controller 80 will reactivate the second current control device 68 that the second battery cell 30 will be charged according to step 612 after the charge current is detected to be less than the critical value.

Although examples are provided above describing the condition that the first battery cell 20 is fully charged and the second battery cell 30 is not fully charged, similar procedure applies when alternatively the second battery cell 30 is fully charged and the first battery cell 20 is not fully charged. Furthermore, the above steps 610˜614 still apply to perform the charging process when the battery expansion system 300 has three or more than three battery cells, including both fully-charged one(s) and non fully-charged one(s), and balance among these battery cells can be done, too.

Even when in the case that both the first battery cell 20 and the second battery cell 30 are not fully charged, the controller 80 can still determine the electric potential difference between the first battery cell 20 and the second battery cell 30 after executing step 610. Under the safety control that no overload charge current will be provided to one battery cell, the controller 80 may still do the charging to one or two of the battery cells. When the electric potential difference between the battery cells is detected to reach a setting value and the battery expansion system 300 is also connected to the system host 100, the battery cell with lower electrical potential may undergo an overload charge current caused by the in-rush current and the controller 80 responds to activate the charge protection according to step 614.

The battery expansion system and the battery charging and discharging control method configure the cells as an expansion form to connect to a system host such that the charger IC of the system host treats the battery expansion system as a single battery cell for DC charging and discharging control. The battery expansion system utilizes the controller in control of the charge/discharge route for each battery cell. In such way, each battery cells is capable of providing power for the system host or charging another cell until the battery cells are balanced with one another. With the control of a current control device and a charging switch in the charging/discharging route, the controller may effectively limit the charging current toward each cell under the maximum design charging current. Each battery cell of the battery system is capable of detached and replaced at any time so that the battery expansion system has more flexibility in different applications.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A battery expansion system having a single route for charging and discharging, detachably installed on a system host to provide power for the system host or for the system host to charge the battery expansion system, the battery expansion system comprising:
a first battery cell;
a second battery cell;
a first charge and discharge circuit, coupled between the first battery cell and the system host, the first charge and discharge circuit comprising:
a first charge switch, a first discharge switch, and a first current control device, the first discharge switch coupled between the first charge switch and the first current control device, the first current control device coupled to the first battery cell;
a second charge and discharge circuit, coupled between the second battery cell and the system host, the second charge and discharge circuit comprising:
a second charge switch, a second discharge switch, and a second current control device, the first charge switch, the second charge switch, and the system host coupled to one another, the second discharge switch coupled between the second charge switch and the second current control device, the second current control device coupled to the second battery cell; and
a controller, coupled to the first charge and discharge circuit, the second charge and discharge circuit, the first battery cell, and the second battery cell, the controller used for:
activating the first discharge switch or the second discharge switch such that correspondingly the first battery cell or the second battery cell provides power for the system host; and
activating the first charge switch or the second charge switch such that the system host charges correspondingly the first batter cell or the second batter cell.

2. The battery expansion system of claim 1, wherein the controller is further used for activating the first charge switch or the second charge switch, such that correspondingly the second battery cell charges the first battery cell or the first battery cell charges the second battery cell.

3. The battery expansion system of claim 2, wherein the controller is used for activating the second charge switch such that the first battery cell charges the second battery cell when the controller detects electric potential of the first battery cell is greater than electric potential of the second batter cell by a setting value.

4. The battery expansion system of claim 1, wherein the first current control device comprises a first current-limiting circuit and a first current regulation device in parallel connection, the second current control comprises a second current-limiting circuit and a second current regulation device in a parallel connection.

5. The battery expansion system of claim 4, wherein the controller is used for activating the first current regulation device or the second current regulation device such that the first battery cell or the second battery cell provides power for the system host when the controller activates correspondingly the first discharge switch or the second discharge switch.

6. The battery expansion system of claim 4, wherein the controller is used for activating the first current regulation device or the second current regulation device such that the system host charges the first battery cell or the second battery cell when the controller activates correspondingly the first charge switch or the second charge switch.

7. The battery expansion system of claim 4, wherein the controller is used for detecting a charge current of the first battery cell when the controller activates the first charge switch for charging the first battery cell, and the controller is used for deactivating the first current regulation device and activating the first current-limiting circuit to limit the charge current to be less than a critical value when the charge current is greater than the critical value.

8. The battery expansion system of claim 7, wherein the controller is further used for controlling activation and deactivation of the first charge switch by pulse width modulation (PWM) so as to limit the charge current of the first battery cell.

9. The battery expansion system of claim 1, wherein the controller is further used for detecting battery statuses of the first battery cell and the second battery cell and deactivating the first discharge switch when an abnormal battery status of the first battery cell occurs.

10. The battery expansion system of claim 9, wherein the abnormal battery status of the first battery cell comprises one of the following:
the first battery cell absent from coupling to the first discharge circuit;
the controller unable to acquire the battery status of the first battery cell; and
the controller acquiring abnormal information from the first battery cell.

11. The battery expansion system of claim 9, wherein the controller is used for activating the corresponding first discharge switch or the second discharge switch when the battery status of the first battery cell or the second battery cell is normal.

12. The battery expansion system of claim 1, further comprising an expansion seat;
wherein the first battery cell and the second battery cell are detachably installed on the expansion seat;
wherein the first charge and discharge circuit, the second charge and discharge circuit, and the controller are disposed in the expansion seat; and
wherein the first charge and discharge circuit and the second charge and discharge circuit separately provide electrical contacts for electrical connections with the first battery cell and the second battery cell respectively when the first battery cell and the second battery cell are installed on the expansion seat.

13. The battery expansion system of claim 12, wherein the expansion seat is detachably installed on the system host.

14. The battery expansion system of claim 1, wherein the system host charges the battery expansion system by direct current.

15. A battery charging and discharging control method, a battery expansion system having a single route for charging and discharging, detachably installed on a system host to provide power for the system host or for the system host to charge the battery expansion system, the battery expansion system comprising a first battery cell and a second battery cell, the battery charging and discharging control method comprising:
forming a first charge and discharge circuit between the first battery cell and the system host, the first charge and discharge circuit comprising a first charge switch, a first discharge switch, and a first current regulation device, the first discharge switch coupled between the first charge switch and the first current regulation device, the first current regulation device coupled to the first battery unit;
forming a second charge and discharge circuit between the second battery cell and the system host, the second charge and discharge circuit comprising a second charge switch, a second discharge switch, and a second current regulation device, the first charge switch, the second charge switch and the system host coupled to each other, the second discharge switch coupled between the second charge switch and the second current regulation device, the second current regulation device coupled to the second battery unit;
activating the first discharge switch or the second discharge switch such that correspondingly the first battery cell or the second battery cell provides power for the system host; and
activating the first charge switch or the second charge switch such that the system host charges correspondingly the first battery cell or the second battery cell.

16. The battery charging and discharging control method of claim 15, further comprising:
activating the first charge switch or the second charge switch such that correspondingly the second battery cell charges the first battery cell or the first battery cell charges the second battery cell.

17. The battery charging and discharging control method of claim 16, further comprising:
activating the second charge switch such that the first battery cell charges the second battery cell when electric potential of the first battery is greater than electric potential of the second battery by a setting value.

18. The battery charging and discharging control method of claim 15, wherein the first current control device comprises a first current-limiting circuit and a first current regulation device in a parallel connection and the second current control device comprises a second current-limiting circuit and a second current regulation device in a parallel connection, the battery charging and discharging control method further comprising:
activating the first current regulation device or the second current regulation device such that the first battery cell or the second battery cell provides power for the system host when activating correspondingly the first discharge switch or the second discharge switch.

19. The battery charging and discharging control method of claim 18, further comprising:
activating the first current regulation device or the second current regulation device such that the system host charges the first battery cell or the second battery cell when activating correspondingly the first charge switch or the second charge switch.

20. The battery charging and discharging control method of claim 18, further comprising:
detecting a charge current of the first battery cell when activating the first charge switch for charging the first battery cell, and deactivating the first current regulation device and activating the first current-limiting circuit to limit the charge current to be less than a critical value when the charge current is greater than the critical value.

21. The battery charging and discharging control method of claim 20, further comprising:
controlling activation and deactivation of the first charge switch by pulse width modulation (PWM) so as to limit the charge current of the first battery cell.

22. The battery charging and discharging control method of claim 15, further comprising:
detecting battery statuses of the first battery cell and the second battery cell and deactivating the first discharge switch when an abnormal battery status of the first battery cell occurs.

23. The battery charging and discharging control method of claim 22, wherein deactivating the first discharge switch when the abnormal battery status of the first battery cell occurs comprises deactivating the first discharge switch when:
the first battery cell is absent from coupling to the first discharge circuit;
the controller is unable to acquire the battery status of the first battery cell; or
the controller acquires abnormal information from the first battery cell.

24. The battery charging and discharging control method of claim 22, further comprising:
activating correspondingly the first discharge switch or the second discharge switch when the battery status of the first battery cell or the second battery cell is normal.

25. The battery charging and discharging control method of claim 15, further comprising:
providing an expansion seat;
detachably installing the first battery cell and the second battery cell on the expansion seat;
disposing the first charge and discharge circuit, the second charge and discharge circuit, and the controller in the expansion seat; and
providing electrical contacts separately by the first charge and discharge circuit and the second charge and discharge circuit for electrical connections with the first battery cell and the second battery cell respectively when the first battery cell and the second battery cell are installed on the expansion seat.

26. The battery charging and discharging control method of claim 15, further comprising:
the system host charging the battery expansion system by direct current.
